(19) United States
(12) Patent Application Publication
(10) Pub. No.: US 2016/0019627 A1
(43) Pub. Date: Jan. 21, 2016

(54) INITIAL PROFILE CREATION IN A MEDIA RECOMMENDATION SYSTEM

(71) Applicant: Luma, LLC, St. Louis Park, MN (US)

(72) Inventors: James Musil, Minneapolis, MN (US); Aaron Weber, Orono, MN (US); Colin Keeley, Minneapolis, MN (US)

(21) Appl. No.: 14/854,236

(22) Filed: Sep. 15, 2015

Related U.S. Application Data
(63) Continuation-in-part of application No. 14/483,452, filed on Sep. 11, 2014.
Application No. 14/483,452 is a continuation-in-part of application No. 14/832,279, filed on Aug. 21, 2015.
Application No. 14/832,279 is a continuation-in-part of application No. 13/792,729, filed on Mar. 11, 2013.
Application No. 13/792,729 is a continuation-in-part of application No. 12/892,274, filed on Sep. 28, 2010, now Pat. No. 8,401,983.
Application No. 12/892,274 is a continuation-in-part of application No. 12/892,320, filed on Sep. 28, 2010, now Pat. No. 8,825,574.
Application No. 12/892,320 is a continuation-in-part of application No. 12/903,830, filed on Oct. 13, 2010.
(60) Provisional application No. 61/876,653, filed on Sep. 11, 2013.
(60) Provisional application No. 61/251,191, filed on Oct. 13, 2009.

(51) Int. Cl. G06Q 30/06

(52) U.S. Cl. CPC G06Q 30/0631

(57) ABSTRACT

A method of operating a recommendation system comprises receiving one or more elements of identifying information for a first user, and receiving one or more user demographic elements associated with the first user based on the received identifying information. The recommendation system generates an initial media preference profile from correlation between the one or more user demographic elements and media preferences known to be associated with the one or more user demographic elements.

### CROSS-REFERENCE TO RELATED APPLICATIONS

This application is a continuation-in-part of U.S. patent application Ser. No. 14/483,452, filed on Sep. 11, 2014, which claims the benefit of U.S. Provisional Application No. 61/876,653, filed on Sep. 11, 2013. This application is also a continuation-in-part of U.S. patent application Ser. No. 14/832,279, filed on Aug. 21, 2015, which is a continuation-in-part of U.S. patent application Ser. No. 13/792,729, filed on Mar. 11, 2013, which is a continuation-in-part of U.S. patent application Ser. No. 12/892,274, now U.S. Pat. No. 8,401,983, filed on Sep. 28, 2010. The present application is further continuation-in-part of U.S. patent application Ser. No. 12/892,320, now U.S. Pat. No. 8,825,574, filed on Sep. 28, 2010. This application is further continuation-in-part of U.S. patent application Ser. No. 12/903,830, filed on Oct. 13, 2010, and which claims the priority of U.S. Provisional Application No. 61/251,191, filed on Oct. 13, 2009. All of the U.S. priority applications are herein incorporated by reference.

### FIELD

The invention relates generally to media item recommendation, and more specifically to initial profile creation in a media recommendation system.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as eBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives the majority of its profits from sale of physical media, and increases its profit from providing a customer with media recommendations similar to items that a customer has already purchased.

Recommendations such as these are typically made by employing a recommendation engine to identify media that is similar to other media in which a customer has shown an interest, such as by purchasing, renting, or rating related media. Pandora, for example, uses an expert's characterization of a song using domain knowledge attributes such as structure, instrumentation, rhythm, and lyrical content to produce domain knowledge data for each song, and provides streaming songs matching identified customer preferences for one or more distinct customized stations based on its domain knowledge-based recommendation engine. Other media providers such as Netflix provide correlation-based recommendations, where user preferences for similar movies over a broad base of users and media are used to find preference correlation between the media and users in the database to recommend media correlated to other media a customer has liked.

Because the number of items purchased or the length of a subscription are related to the value customers receive in continuing to interact with a media provider, it is in the provider's best interest to provide media recommendations that are accurate and well-tailored to its customers, and that are usable in a variety of media use environments. But, the quality of media recommendations in many systems is related to the amount and quality of information regarding each individual user's preferences. It is therefore desirable to accurately estimate user preferences to provide the best quality media recommendations.

### SUMMARY

One example embodiment of the invention comprises a method of operating a recommendation system, including receiving one or more elements of identifying information for a first user, and receiving one or more user demographic elements associated with the first user based on the received identifying information. The recommendation system generates an initial media preference profile from correlation between the one or more user demographic elements and media preferences known to be associated with the one or more user demographic elements.

In a further example, identifying information comprises at least one of email address, social media identification, or unique user identification, and user demographic elements comprise at least one of age, gender, location, race, religion, and income.

In another example, a media recommendation system comprises a processor, and a user profile module comprising instructions executable on the processor. The instructions are operable when executed to receive one or more elements of identifying information for a first user, and to receive one or more user demographic elements associated with the first user based on the received identifying information. The recommendation system executes instructions to generate an initial media preference profile from correlation between the one or more user demographic elements and media preferences known to be associated with the one or more user demographic elements.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a media recommendation system including an initial profile creation module, consistent with an example embodiment of the invention.

FIG. 2 is a block diagram illustrating information used in an initial profile creation module, consistent with an example embodiment of the invention.

FIG. 3 is a block diagram of a media recommendation system comprising an initial profile creation module operable to use local demographics and third-party demographics, consistent with an example embodiment of the invention.

FIG. 4 is a flowchart of a method of initial profile generation, consistent with an example embodiment of the invention.

FIG. 5 is a computerized media recommendation system comprising an initial profile creation module, consistent with an example embodiment of the invention.

FIG. 6 is a computerized media recommendation system comprising an initial profile creation module, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Recommendation of media such as books, movies, or music that a customer is likely to enjoy can improve the sales of online merchants such as Amazon, improve the subscription rate and customer duration of rental services such as Netflix, and help the utilization rate of advertising-driven services such as Pandora. Although revenue is derived from providing media in different ways in each of these examples, they all benefit from providing good quality recommendations to customers regarding potential media purchases, rentals, or other media use. Similarly, knowledge of a user's preferences and interests can help target advertising that is relevant to a particular user, such as advertising horror movies only to those who have shown an interest in honor films, targeting country music advertising toward those who prefer country to rap or pop music, and presenting advertising for a new book to those who have shown a preference for similar books.

Media recommendations such as these are typically made by employing a recommendation engine to identify media that is similar to other media in which a customer has shown an interest, such as by purchasing, renting, or rating other similar media. Some websites, such as Netflix, ask a user to rate dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a customer receives in interacting with a media provider, it is in the provider's best interest to provide media recommendations that are accurate and well-suited to its customers. Poor recommendations may result in a user abandoning a service or merchant for another, while good recommendations will likely result in additional sales and profit. It is therefore desirable to accurately characterize and predict a user's media preferences to provide the best quality media recommendations possible.

Making accurate recommendations relies in part in having accurate data regarding characteristics of media that may be recommended, so that information regarding a user's preferences can be used to accurately search through media to select items to recommend. For example, a system such as Pandora that relies on domain knowledge of songs to recommend other songs relies on accurate expert characterization of various attributes of each song in its library to enable songs to be found and recommended based on the characterized attributes. Other recommendation systems rely more heavily on correlation, such as determining what other items a user who likes a certain movie is most likely to like by mining a database of user ratings or preference information.

Accurate recommendations further rely in part on accurate characterization of an individual user's media preferences. Although the overall or group rating of the quality of a media item such as a movie can provide some indication of how an average user may like a particular media item, customization of recommendations based on the tastes and preferences of individual users provides individual users with more meaningful and consistently high quality recommendations.

Taste profiles for individual users are typically built over time using known user preferences, such as by having a user rate each movie viewed or song heard, and using the gathered preference information to build a database of user preferences that can be used with methods such as media item correlation and domain knowledge of media items to recommend additional media items. But, media recommendation systems often have little useful knowledge regarding media preferences for a new user, and so have some difficulty making meaningful personalized recommendations until sufficient taste or preference information is gathered.

Some embodiments of the invention therefore employ initial user profiles based on demographic or other known information, such as by using identifying information for the new user to gather demographic information associated with the user, and generating an initial media preference profile from the gathered demographic information. In a more detailed example, a media recommendation system receives one or more identifying elements for a new user, such as email address, name, birthdate, social media user name, or other identifier, and uses the identifying information to receive one or more demographic elements associated with the identifying information. For example, an email address may be used to retrieve demographic information from subscribed sites such as Facebook and from a third-party demographic service.

The demographic information obtained, such as age, gender, location, race, religion, income, and other such information can then be used to generate an initial media preference profile, using known correlation between the one or more demographic elements and media preferences known to be associated with the one or more demographic elements. Correlation between demographic elements and media preferences is determined in one example using data collected by the media recommendation system, and in other examples relies on information provided by third-party demographic providers such as Nielsen Holdings.

In a further example, a media recommendation system strengthens an initial profile by confirming one or more key assumptions, such as whether a user likes a particular genre of movie, a particular type of music, or taste or preference assumption in the initial media preference profile derived from the demographic elements. In various examples, as a user selects media items for viewing, purchase, listening, or rental, and optionally rates the media items, user selection and rating information is used to either refine the initial media preference profile or to create a separate known user preference profile.

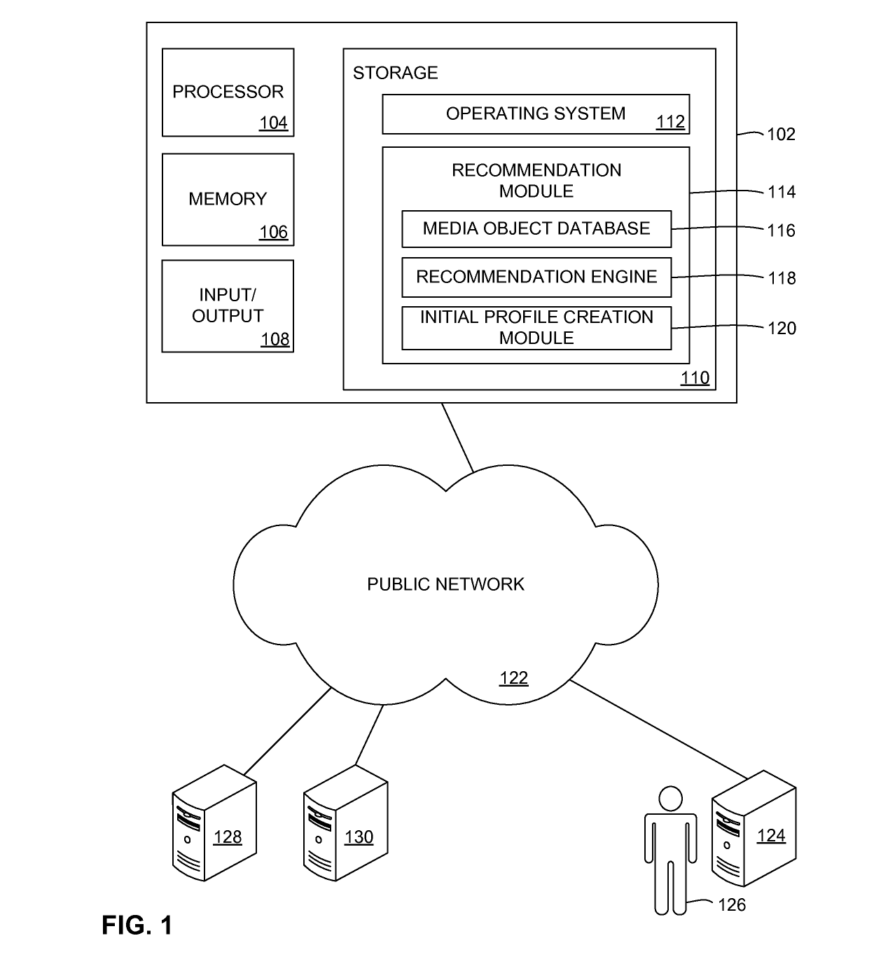

FIG. 1 shows a media recommendation system including initial media preference profile creation, consistent with an example embodiment of the invention. Here, media recommendation system 102 comprises a processor 104, memory 106, input/output elements 108, and storage 110. Storage 110 includes an operating system 112, and a recommendation module 114 that is operable to provide media item recommendations to a user. The recommendation module 114 further comprises a media object database 116 operable to store media object information and user preference information for various media objects. A recommendation engine 118 is operable to use the stored media preference information for various recommendation system users to provide media recommendations. Initial profile creation module 120 is operable to use demographic elements associated with a user to generate an initial media preference profile, such as by using demographic elements retrieved from a third-party service, signup information, or other user-subscribed sites such as Facebook.

The media recommendation system 102 is connected to a public network 122, such as the Internet. Public network 122 serves to connect the media recommendation system 102 to remote computer systems, including user computer 124 (associated with user 126). Media recommendation system 102 is further connected to third-party demographic profile server 128, and third-party user demographic information server 130.

In operation, the media recommendation system's processor 104 executes program instructions loaded from storage 110 into memory 106, such as operating system 112 and recommendation module 114. The recommendation module includes software executable to create an initial profile for users such as user 126, using demographic profile information such as from server 128 and user demographic information such as from server 130.

The media item recommendations generated by recommendation engine 118 are based in some examples upon media preference information derived from the user information and demographic profile information, such as user information regarding a user's age, gender, location, race, religion, and income. This user information is used in conjunction with demographic profile information regarding these various user characteristics to produce an initial profile, via initial profile creation module 120. The media recommendation system 102 then uses recommendation engine 118 and media object database 116 to generate media recommendations consistent with the user's initial profile. Recommendations are generated and provided to the user using correlation-based recommendations, domain knowledge-based recommendations, or recommendations made using a combination of correlation-based and domain knowledge-based information.

In a more detailed example, a new user such as 126 inputs one or more pieces of identifying information, such as an email address, social media user ID, name, address, phone number, or other such information. This information is used to retrieve various user demographic information, such as by using social media identifying information to retrieve various user demographic information from the social media site, or using an email address with a third-party user profile server such as 130 to retrieve known information regarding the user. In other embodiments, the user inputs at least some user demographic information, and the user demographic information includes known interests, such as preferences for goods, services, or other non-media items.

The initial profile creation module 120 then uses the user demographic information in combination with demographic profile information regarding known correlation between user demographic information and media preferences to create an initial user profile. For example, if user 126 is known to be male rather than female, this user demographic information may be used with demographic profile information reflecting that males are more likely to enjoy action movies than romantic comedies in forming the user's initial profile.

In another example, third-party demographic profile server 128 is not employed, and the initial profile creation module maintains its own demographic profile database of correlation between user demographic information and media preference. Such a database may be built over time as a user base grows, such that a third-party demographic profile service is used initially, but an internal demographic profile database is employed once the demographic profile database becomes more robust. In a more detailed example, the third-party demographic service information cannot be conveyed directly to a consumer due to contract restrictions, but local demographic profile database information that is separately maintained is used to provide information to the user regarding correlation between user demographic information and recommendations. For example, the recommendation engine may recommend a movie to a user, indicating that 87% of males between 18-24 years old enjoyed the movie and that users with a higher income liked the movie somewhat better than those with lower incomes, based on information from a local demographic profile database.

Some embodiments employ methods to ensure that initial profile quality is sufficient to generate quality recommendations, such as asking the user to confirm key assumptions in generating the initial profile. Such key assumptions include genre preference information, user demographic information, and other information that may affect the user's initial profile and the recommendations that result from the initial profile. Other examples include using user's media selections, reviews, and other such information to either refine the initial profile, or to create a separate permanent user profile that is used to improve the recommendation module 114's ability to provide quality recommendations. In some such examples, more weight is given to results obtained from the permanent user profile as the permanent user profile includes more information, such as a greater number of media items reviewed, previewed, viewed, or purchased.

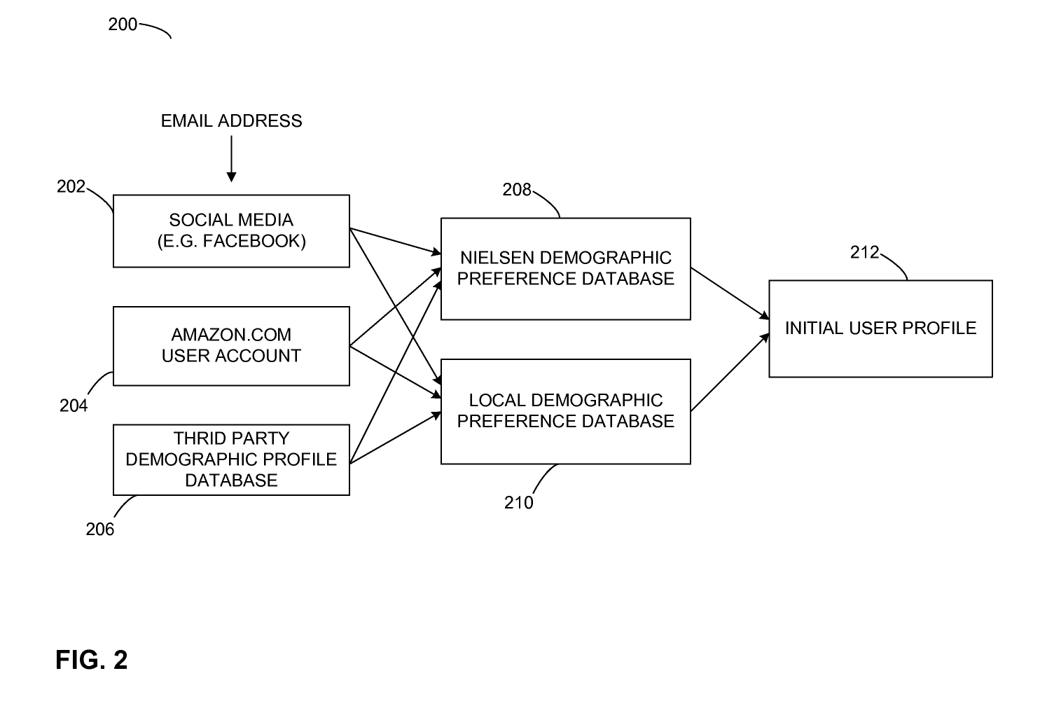

FIG. 2 shows a block diagram illustrating information used in an initial profile creation module, consistent with an example embodiment of the invention. As shown generally at 200, a new user provides identifying information such as an email address or social media identification to a media recommendation system's initial profile creation module. This information is used to identify the user to social media, shopping, and other services. In a further example, identifying information is provided to a third-party demographic profile database 206, which is operable to provide user demographic information associated with identifying information such as an email address.

User demographic information, such as age, gender, location, race, religion, income, and the like are provided from social media accounts 202 such as Facebook, merchant accounts such as Amazon.com, and third-party user demographic profile databases 206 to an initial profile creation module of the media recommendation system, where they are applied to one or more demographic preference databases. In the example of FIG. 2, the user demographic information is applied against data from a Nielsen (third-party) demographic preference database 208, and against a demographic preference database 210 local to the media recommendation system.

Unser demographic information such as age, gender, income, and other information are the applied to known preferences for these various demographics using the demographic preference databases 208 and/or 210, resulting in predicted user preferences for various media items. The initial profile creation module uses these preferences to generate initial user profile 212, which can then be used to make media recommendations for the new user.

In some embodiments, information from third-party demographic preference databases such as Nielsen demographic preference database 208 cannot be presented directly to an end user due to licensing restrictions placed on the third party data (e.g. 87% of male Catholics between 25-39 liked this movie), but information from a local demographic database 210 does not have such restrictions. Such local demographic database information is therefore presented to users with media recommendations in some embodiments, providing users with more information regarding the reasons behind recommendations received based on their initial profile.

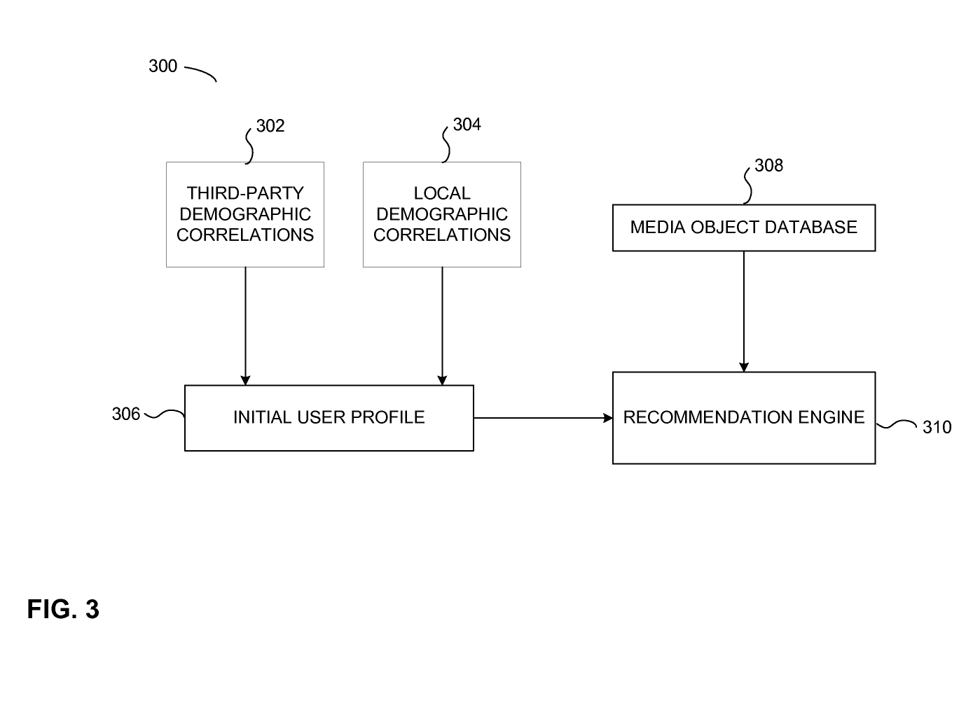

FIG. 3 shows a media recommendation system comprising an initial profile creation module operable to use local demographics and third-party demographics, consistent with an example embodiment of the invention. Here, a third-party demographic service such as Nielsen provides demographic correlation information, such as preferences for certain types of media or certain media items for various demographic groups. For example, a media item such as movie may have various associated demographic information, such as knowledge that the movie is liked by 82% of men but only 54% of women, is liked by certain age groups more than others, and the like. Demographic categories include in various embodiments age, sex, religion, income, geographic location, occupation, marital/family status, education, and other such demographic characteristics.

An initial profile creation module can use this correlation information between demographic characteristics and media preference to create an initial user profile, as shown at 306. The initial user profile in this example comprises information regarding a user's anticipated preferences for one or more media items, or for one or more groups of media items. In a further example, the demographic correlations and known user demographics are applied against one or more media items from a media object database 310 to generate the initial user profile. A recommendation engine 308 in the media recommendation system can then use this initial profile to provide media recommendations, using media database 308 and initial user profile 306.

Information from the third-party demographic service in some examples may be made available with license restrictions, and may be costly to use. Over time, the media recommendation system shown will therefore build its own database of local demographic correlations that can be used to build an initial user profile, as shown at 304. For example, Nielsen demographic database users may be restricted from directly conveying demographic information to a user, whereas no such restriction exists for a locally produced demographic correlation database. This enables the recommendation engine 308 to include demographic information regarding a media item to a user, such as indicating that a large percentage of people sharing specific demographic characteristics with the user enjoyed the movie. For example, a recommendation for the movie “The Godfather” may indicate that people of all income ranges enjoyed the movie, but that men in particular rated it very high, as did people over the age of 34. Such information may help a user decide between media items, particularly when the recommendations are made on the basis of an initial user profile rather than a profile substantially based on known user preferences.

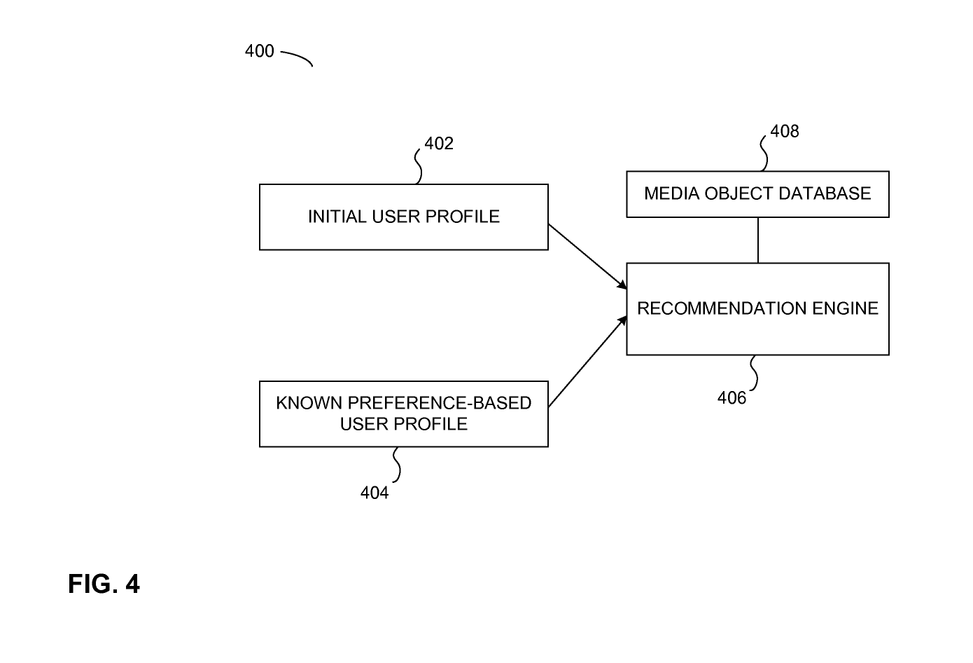

FIG. 4 shows a media recommendation system comprising separate initial user profiles and known preference-based user profiles, consistent with an example embodiment of the invention. Here, media recommendation system 400's initial profile creation module creates initial user profile 402, using user demographic profile information and correlation between various demographic characteristics and media preferences. This enables recommendation engine 406 to recommend media objects from media object database 408 to a new user with an initial user profile 402.

As the new user rates, views, or otherwise interacts with various media items, the media recommendation system 400 builds known preference-based user profile 404. This known preference-based user profile will be a more accurate representation of the user's media tastes and preferences over time, as it reflects the unique preferences of the actual user rather than estimates based on the user's demographic characteristics. The media recommendation system will therefore desirably transition to using the known preference-based user profile 404 over the initial user profile 402 as the known preference-based user profile becomes more robust.

This transition between profiles occurs in some embodiments when a threshold number of media ratings are available to known preference-based user profile 404, or when another threshold of quality for the known preference-based user profile is reached. In another example, both profiles are used simultaneously to make at least some media recommendations, but the influence of the initial user profile 402 and the known preference-based user profile 404 are weighted based on the relative strength or robustness of the known preference-based user profile 404.

In still other embodiments, a single user profile is maintained, such as where a handful of demographic-based assumptions made in initial user profile 402 are eventually outweighed by a robust set of known user preferences such as media reviews provided by the user over time.

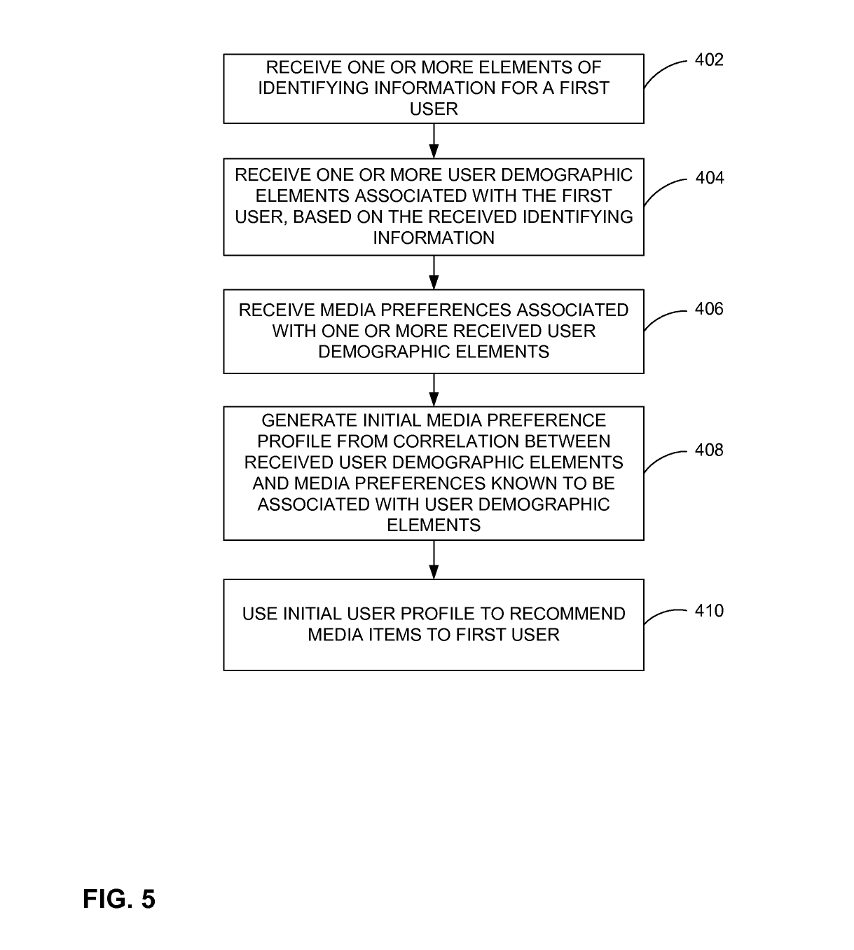

FIG. 5 is a flowchart of a method of creating an initial user profile to provide media recommendations to a new user, consistent with an example embodiment of the invention. Here, a media recommendation system's initial profile creation module receives one or more elements of identifying information for a first user at 402, such as an email address, social security number, social media website userid, name and home address, or other such identifying information.

The initial profile creation module uses this identifying information to retrieve one or more user demographic elements associated with the first user at 404, such as by using an email address to query a third party demographic profile service for information regarding a user, or by searching an associated social media website for demographic information.

The initial profile creation module then receives media preferences associated with one or more received user demographic elements at 406, such as by retrieving the associated media preferences from a third-party service such as Nielsen, or retrieving the associated media preferences from a database such as media object database 116 or another such database. The received media preferences associated with the one or more received user demographic elements are used to generate an initial media preference profile at 408, such that the media recommendation system can use the initial profile derived from the received media preferences can be used to recommend media items to the user at 410.

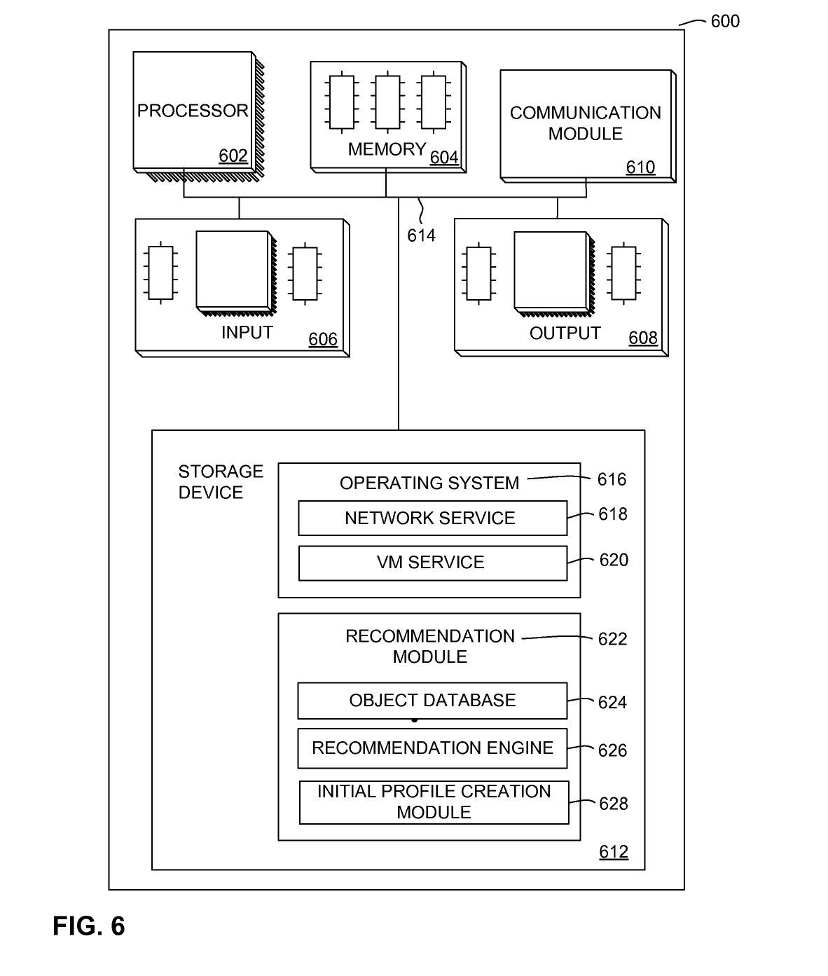

FIG. 6 is a computerized media recommendation system comprising an initial profile creation module, consistent with an example embodiment of the invention. FIG. 6 illustrates only one particular example of computing device 600, and other computing devices 600 may be used in other embodiments. Although computing device 600 is shown as a standalone computing device, computing device 600 may be any component or system that includes one or more processors or another suitable computing environment for executing software instructions in other examples, and need not include all of the elements shown here.

As shown in the specific example of FIG. 6, computing device 600 includes one or more processors 602, memory 604, one or more input devices 606, one or more output devices 608, one or more communication modules 610, and one or more storage devices 612. Computing device 600, in one example, further includes an operating system 616 executable by computing device 600. The operating system includes in various examples services such as a network service 618 and a virtual machine service 620 such as a virtual server. One or more applications, such as recommendation module 622 are also stored on storage device 612, and are executable by computing device 600.

Each of components 602, 604, 606, 608, 610, and 612 may be interconnected (physically, communicatively, and/or operatively) for inter-component communications, such as via one or more communications channels 614. In some examples, communication channels 614 include a system bus, network connection, inter-processor communication network, or any other channel for communicating data. Applications such as recommendation module 622 and operating system 616 may also communicate information with one another as well as with other components in computing device 600.

Processors 602, in one example, are configured to implement functionality and/or process instructions for execution within computing device 600. For example, processors 602 may be capable of processing instructions stored in storage device 612 or memory 604. Examples of processors 602 include any one or more of a microprocessor, a controller, a digital signal processor (DSP), an application specific integrated circuit (ASIC), a field-programmable gate array (FPGA), or similar discrete or integrated logic circuitry.

One or more storage devices 612 may be configured to store information within computing device 600 during operation. Storage device 612, in some examples, is known as a computer-readable storage medium. In some examples, storage device 612 comprises temporary memory, meaning that a primary purpose of storage device 612 is not long-term storage. Storage device 612 in some examples is a volatile memory, meaning that storage device 612 does not maintain stored contents when computing device 600 is turned off. In other examples, data is loaded from storage device 612 into memory 604 during operation. Examples of volatile memories include random access memories (RAM), dynamic random access memories (DRAM), static random access memories (SRAM), and other forms of volatile memories known in the art. In some examples, storage device 612 is used to store program instructions for execution by processors 602. Storage device 612 and memory 604, in various examples, are used by software or applications running on computing device 600 such as recommendation module 622 to temporarily store information during program execution.

Storage device 612, in some examples, includes one or more computer-readable storage media that may be configured to store larger amounts of information than volatile memory. Storage device 612 may further be configured for long-term storage of information. In some examples, storage devices 612 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 600, in some examples, also includes one or more communication modules 610. Computing device 600 in one example uses communication module 610 to communicate with external devices via one or more networks, such as one or more wireless networks. Communication module 610 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communication s (NFC), and Universal Serial Bus (USB). In some examples, computing device 600 uses communication module 610 to wirelessly communicate with an external device such as via public network 122 of FIG. 1.

Computing device 600 also includes in one example one or more input devices 606. Input device 606, in some examples, is configured to receive input from a user through tactile, audio, or video input. Examples of input device 606 include a touchscreen display, a mouse, a keyboard, a voice responsive system, video camera, microphone or any other type of device for detecting input from a user.

One or more output devices 608 may also be included in computing device 600. Output device 608, in some examples, is configured to provide output to a user using tactile, audio, or video stimuli. Output device 608, in one example, includes a display, a sound card, a video graphics adapter card, or any other type of device for converting a signal into an appropriate form understandable to humans or machines. Additional examples of output device 608 include a speaker, a light-emitting diode (LED) display, a liquid crystal display (LCD), or any other type of device that can generate output to a user.

Computing device 600 may include operating system 616. Operating system 616, in some examples, controls the operation of components of computing device 600, and provides an interface from various applications such as recommendation module 622 to components of computing device 600. For example, operating system 616, in one example, facilitates the communication of various applications such as recommendation module 622 with processors 602, communication unit 610, storage device 612, input device 606, and output device 608. Applications such as recommendation module 622 may include program instructions and/or data that are executable by computing device 600. As one example, recommendation module 622 and its object database 624, recommendation engine 626, and initial profile creation module 628 may include instructions that cause computing device 600 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of operating a media recommendation system, comprising:
receiving one or more elements of identifying information for a first user;
receiving one or more user demographic elements associated with the first user based on the received identifying information;
generating an initial media preference profile from correlation between the one or more user demographic elements and media preferences known to be associated with the one or more user demographic elements.

2. The method of operating a media recommendation system of claim 1, wherein the identifying information comprises at least one of email address, social media identification, or unique user identification.

3. The method of operating a media recommendation system of claim 1, wherein user demographic elements comprise at least one of age, gender, location, race, religion, and income.

4. The method of operating a media recommendation system of claim 1, wherein the one or more user demographic elements comprise at least one of known interests, non-media goods preferences, and non-media services preferences.

5. The method of operating a media recommendation system of claim 1, wherein the one or more user demographic elements are retrieved from accounts on one or more user-indicated associated accounts.

6. The method of operating a media recommendation system of claim 1, wherein the one or more user demographic elements for the user are retrieved from a third party user profile service.

7. The method of operating a media recommendation system of claim 1, wherein the correlation between the one or more user demographic elements and media preferences known to be associated with the one or more demographic elements is obtained from a third party demographic profile service.

8. The method of operating a media recommendation system of claim 1, wherein the correlation between the one or more user demographic elements and media preferences known to be associated with the one or more demographic elements is based on an observed correlations across users of the recommendation system.

9. The method of operating a media recommendation system of claim 1, further comprising asking the first user to confirm key correlation assumptions to strengthen the initial media preference profile.

10. The method of operating a media recommendation system of claim 1, further comprising using the first user's known media selection to improve the initial media preference profile.

11. The method of operating a media recommendation system of claim 1, further comprising using the first user's known media ratings to improve the initial media preference profile.

12. The method of operating a media recommendation system of claim 1, further comprising tracking the initial media preference profile and a known user preference profile separately.

13. The method of operating a media recommendation system of claim 1, further comprising weighting user-verified media preferences higher than the initial media preference profile in forming a composite media preference profile for media recommendation.

14. The method of claim 13, wherein user-verified media preferences comprise at least one of media the user has rated, media the user has purchased, media the user has viewed, media the user has previewed, and media preferences explicitly indicated by the user.

15. A media recommendation system, comprising:
a processor; and
a user profile module comprising instructions executable on the processor that are operable when executed to:
receive one or more elements of identifying information for a first user;
receive one or more user demographic elements associated with the first user based on the received identifying information;
generate an initial media preference profile from correlation between the one or more user demographic elements and media preferences known to be associated with the one or more user demographic elements.

16. The media recommendation system of claim 15, wherein the identifying information comprises at least one of email address, social media identification, or unique user identification.

17. The media recommendation system of claim 15, wherein user demographic elements comprise at least one of age, gender, location, race, religion, income, known interests, non-media goods preferences, and non-media services preferences.

18. The media recommendation system of claim 15, wherein the one or more user demographic elements are retrieved from accounts on one or more user-indicated associated accounts.

19. The media recommendation system of claim 15, wherein the correlation between the one or more user demographic elements and media preferences known to be associated with the one or more user demographic elements is obtained from a third party demographic profile service or is based on an observed correlations across users of the recommendation system.

20. The media recommendation system of claim 15, the user profile module instructions further operable when executed to track the initial media preference profile and a known user preference profile separately.
